(19) United States
(12) Patent Application Publication
(10) Pub. No.: US 2006/0174444 A1
(43) Pub. Date: Aug. 10, 2006

(54) Opening/closing device for a flap door for furniture

(75) Inventor: Antonio Giovannetti, Segrate (MI) (IT)

Correspondence Address: NIXON & VANDERHYE, PC, 901 NORTH GLEBE ROAD, 11TH FLOOR, ARLINGTON, VA, 22203, US

(73) Assignee: Effegi Brevetti S.R.L., Segrate (MI) (IT)

(21) Appl. No.: 11/341,577

(22) Filed: Jan. 30, 2006

(30) Foreign Application Priority Data
Feb. 9, 2005 (IT) MI2005A 000181

(51) Int. Cl. E05D 7/00

(52) U.S. Cl. 16/354

(57) ABSTRACT

An opening/closing device (1) is described in the form of an articulated pentalateral with two centres of rotation (17,18) connected to each other by means of gears, able to open/close a flap door (2) of an item of furniture (3) and comprising a support (4) to which are hinged at least a first and a second arm (5, 6) coupled to each other by means of two toothed areas (7, 8) formed on the outer surfaces of the ends of the first arm (5) and of the second arm (6), which are hinged to the support (4) by means of pivots which form the above centres of rotation (17, 18).

One end of the element (9) which carries the flap door (2) is hinged to the other end of the second arm (6) by means of a pivot forming the axis of rotation (11) of the flap door (2): on opening of the flap door (2) the second arm (6) is made to rotate towards the outside of the item of furniture (3) by rotation of the first arm (5), shifting the axis of rotation (11) of the flap door (2) towards the outside of the item of furniture (3) and allowing opening thereof even if the flap door (2), when closed, is superimposed on the upper part of the frame of the item of furniture (3).

The present invention refers to an opening/closing device for a flap door for furniture, designed to make the flap door rotate upwards, with a gradual movement, until a substantially horizontal open position is reached, and respectively to make the flap door rotate downwards until a substantially vertical closed position is reached.

Many types of opening/closing devices for flap doors are known to the art, based on the principle of the articulated quadrilateral, whose structural elements and operation will not be described herein because they are per se known.

Object of the present invention is to produce an opening/closing device for a furniture flap door which, though maintaining and improving the performance of articulated quadrilateral devices of the prior art, has aesthetic and functional features which increase the quality thereof, as required by current design and market trends.

This object is achieved though the use of an articulated pentalateral which has the characterising elements illustrated in claim 1, that is, which has two centres of rotation connected to each other by means of gears.

The above connection makes it possible, by varying the gear ratio, to control the movement of one arm of the pentalateral with respect to another arm of the pentalateral.

Further advantageous characteristics of the invention form the subject matter of the dependent claims.

The invention will now be described with reference to a purely exemplifying (and therefore non limiting) embodiment thereof, illustrated in the appended figures in which:

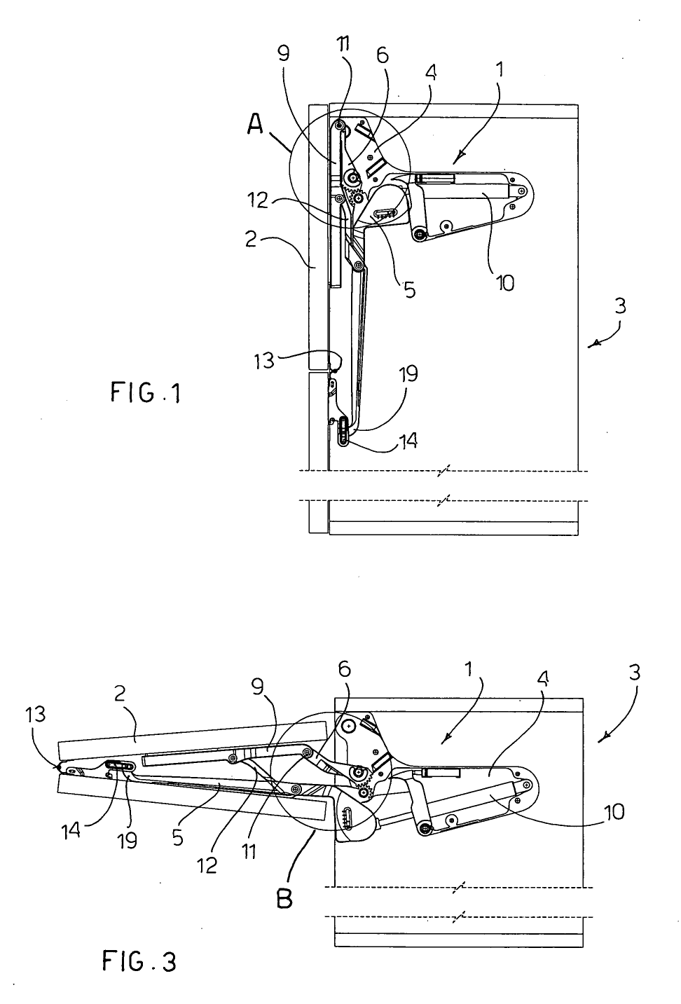

FIG. 1 shows diagrammatically an opening/closing device according to the invention with the flap door in the closed position;

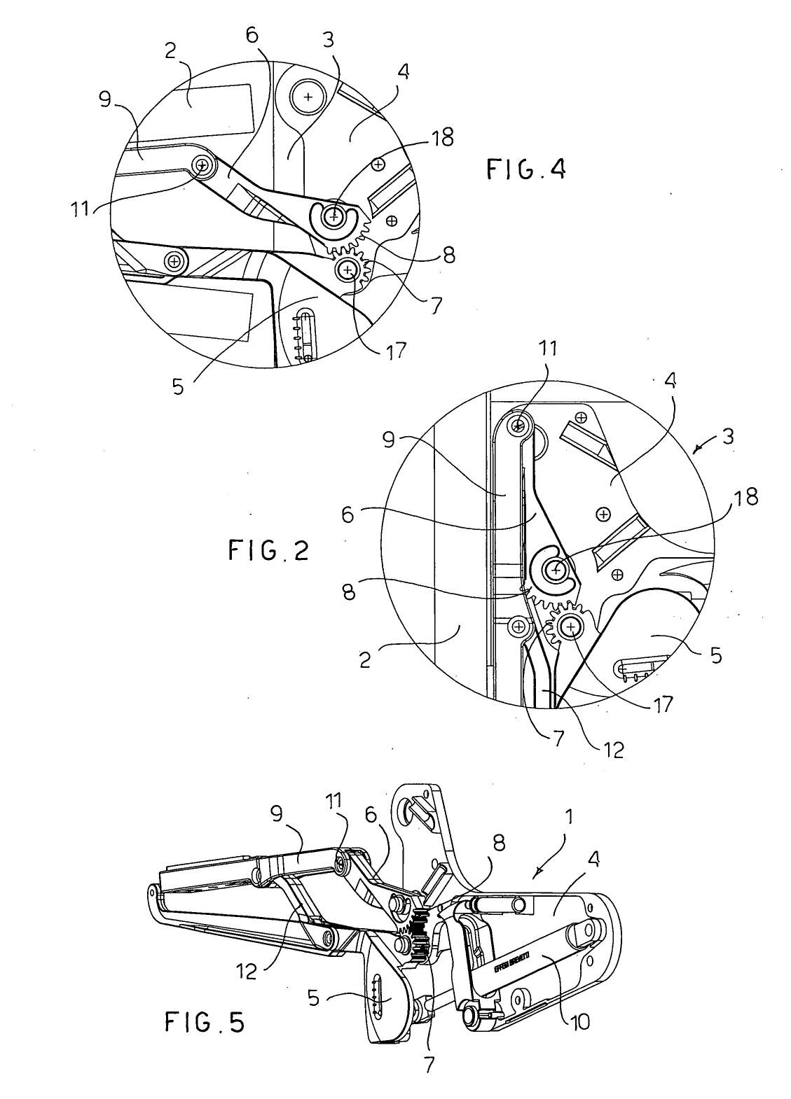

FIG. 2 shows diagrammatically the detail A highlighted in FIG. 1, enlarged;

FIG. 3 shows diagrammatically the opening/closing device of FIG. 1, with the flap door in the open position;

FIG. 4 shows diagrammatically the detail B highlighted in FIG. 3, enlarged;

FIG. 5 shows diagrammatically a perspective view of the opening/closing device of FIG. 3.

In the appended figures corresponding elements will be denoted by the same reference numerals.

FIG. 1 shows diagrammatically an opening/closing device 1, of the articulated pentalateral type, made according to the invention and denoted as a whole by reference numeral 1, with the flap door 2 in the closed position.

From FIG. 1 it can be seen that the flap door 2, when closed, is superimposed on the top part of the frame of the item of furniture 3 and hides it.

The opening/closing device 1 comprises a support 4, fixed to a side wall of the item of furniture 3, to which are hinged at least a first and a second arm (5, 6) connected to each other by means of two toothed areas (7, 8) formed on the outer surfaces of the ends of the first arm 5 and of the second arm 6 which are hinged to the support 4 by means of pivots 17 and 18 (FIGS. 2 and 4), which form the centres of rotation of the articulated pentalateral.

The element 9 which carries the flap door 2 is connected to the first arm 5 by means of a connecting arm 12 and one end of the element 9 is hinged—through the pivot 11 which forms the axis of rotation of the flap door 2—to the end of the second arm 6 opposite the one hinged to the pivot 18.

The toothed areas (7, 8), engaged with one another, which connect to each other the first and second arm (5,6), can be seen better in FIGS. 2, 4 and 5.

In the embodiment described herein, the flap door 2 consists of two parts which, when the flap door 2 is open, fold over each other but, without departing from the scope of the invention, the opening/closing device 1 can be used to operate flap doors 2 in a single piece, eliminating the elements (the hinge 13 placed between the two parts of the flap door 2 and a slide 14, integral with the bottom part of the flap door 2, in which an end 19 of the first arm 5 slides) which allow a flap door 2 in two parts to be operated.

In fact, an opening/closing device 1 made according to the invention and able to operate a flap door 2 in two parts differs from an opening/closing device 1 able to operate a flap door 2 in a single part in that it further comprises (besides the hinge 13 situated between the two parts of the flap door 2) the slide 14, integral with the bottom part of the flap door 2, in which the end 19 of the first arm 5 slides.

Further visible in the appended figures is a gas spring 10, situated between the support 4 and the first arm 5, which facilitates opening and closing of the flap door 2 in a per se known manner.

FIG. 2 shows diagrammatically the detail A highlighted in FIG. 1, enlarged: in FIG. 2 the toothed areas 7 and 8 can be seen better, formed on the outer surfaces of the ends of the first arm 5 and of the second arm 6 (hinged to the support 4 by means of pivots 17 and 18) which are engaged with each other to couple the first and second arm (5, 6) to each other.

From FIG. 2 it can also be seen that when the flap door 2 is closed, the element 9, which carries the flap door 2, is folded back on the second arm 6.

FIG. 3 shows diagrammatically the opening/closing device 1 of FIG. 1 with the flap door 2 in the open position.

When the user raises the flap door 2 to open it, he causes an upward rotation of the first arm 5 which in turn, by means of the toothed areas 7 and 8 engaged with each other, causes the second arm 6 to rotate towards the outside of the item of furniture 3, as can be seen better in FIGS. 4 and 5.

Rotation of the second arm 6 brings towards the outside of the item of furniture 3 the pivot 11 which forms the axis of rotation of the flap door 2, which can therefore rotate outside the item of furniture 3 and bring itself into a horizontal position without interfering with the top part of the frame of the item of furniture 3.

Vice versa, when the user lowers the flap door 2 to close it, he causes a downward rotation of the first arm 5 which in turn, by means of the toothed areas 7 and 8 engaged with each other, causes the second arm 6 and the pivot 11 to rotate towards the inside of the item of furniture 3, returning them to the position shown in FIGS. 1 and 2: the flap door 2 initially rotates outside the item of furniture 3 to return to the vertical position and be superimposed (FIG. 1) on the top part of the frame of the item of furniture 3, hiding it.

FIG. 4 shows diagrammatically, enlarged, the detail B highlighted in FIG. 3, which shows the rotation around the pivot 18 of the second arm 6 to bring the pivot 11 outside the item of furniture 3.

This rotation is also clearly visible in the perspective view of FIG. 5 and is more evident on comparison of FIG. 4 with FIG. 2.

Without departing from the scope of the invention, a person skilled in the art can make to the previously described device for opening/closing a flap door of an item of furniture all the changes and improvements suggested by normal experience or by the evolution of the art.

1. An opening/closing device for the flap door of an item of furniture, characterized in that it consists of an articulated pentalateral having two centres of rotation connected to each other by means of toothed areas.

2. A device as in claim 1, comprising at least one support to which at least a first and a second arm are hinged, characterized in that the first and second arm are coupled to each other by means of toothed areas formed on the outer surfaces of the first ends of the first arm and of the second arm which are hinged to the support by means of pivots which form the centres of rotation of the articulated pentalateral, in that one end of an element which carries the flap door is hinged to the second end of the second arm by means of a pivot forming an axis of rotation of the flap door and in that the element is connected to the first arm by means of a connecting arm.

3. A device as in claim 2, characterized in that, on opening of the flap door, the second arm is made to rotate towards the outside of the item of furniture by rotation of the first arm, moving towards the outside of the item of furniture the axis of rotation of the flap door.

4. A device as in claim 2, characterized in that, on closing of the flap door, the second arm is made to rotate towards the inside of the item of furniture by rotation of the first arm, bringing the axis of rotation of the flap door back inside the item of furniture.

5. A device as in claim 2 able to move a flap door in two parts, characterized in that, besides a hinge situated between the two parts of the flap door, it further comprises a slide, integral with the bottom part of the flap door, in which one end of the first arm slides.
